(19) United States
(12) Patent Application Publication
(10) Pub. No.: US 2013/0329013 A1
(43) Pub. Date: Dec. 12, 2013

(54) HAND HELD DIMENSION CAPTURE APPARATUS, SYSTEM AND METHOD

(71) Applicant: Proiam, LLC, Salem, NH (US)

(72) Inventors: Eric Metois, Arlington, MA (US); Mike Murphy, Salem, NH (US); Mark Durbin, Banbury (GB)

(73) Assignee: PROIAM, LLC, Salem, NH (US)

(21) Appl. No.: 13/965,947

(22) Filed: Aug. 13, 2013

Related U.S. Application Data
(63) Continuation of application No. PCT/US2013/040776, filed on May 13, 2013.
(60) Provisional application No. 61/646,093, filed on May 11, 2012.

(51) Int. Cl. H04N 13/02

(52) U.S. Cl. CPC H04N 13/0203
USPC 348/46

(57) ABSTRACT

A method of determining dimension information indicative of the dimensions of an object is disclosed, the method including: receiving a depth image of the object; and processing the depth information. The processing may include: determining a region of interest (ROI) in the image corresponding to a corner of the object; generating local normal information indicative of local normals corresponding to points in the image; generating, based at least in part on the ROI and the local normal information, object face information indicative of an association of points in the image with sides of the object; and determining the dimension information based at least in part on the object face information.

### CROSS REFERENCE TO RELATED APPLICATIONS

The current application claims the benefit of U.S. Provisional Application No. 61/646093, entitled “HAND HELD DIMENSION CAPTURE APPARATUS, SYSTEM, AND METHOD” filed May 11, 2012, the entire contents of which is incorporated herein by reference.

The current application is related to International Patent Application No. PCT/US2008/084897, entitled “ENROLLMENT APPARATUS, SYSTEM, AND METHOD” filed Nov. 26, 2008 and International Patent Application No. PCT/US2012/037642, entitled “ENROLLMENT APPARATUS, SYSTEM, AND METHOD FEATURING THREE DIMENSIONAL CAMERA”, filed May 11, 2012 (henceforth the “Enrollment Applications”), the entire contents of each of which is incorporated herein by reference

### BACKGROUND

The Enrollment Applications, incorporated by reference above, describe devices for the enrollment of packages. In some instances, a package is placed on a surface, e.g., a stationary surface. A camera is located in a fixed position (e.g., on an extension arm above the package) relative to the surface. The camera obtains images of the package and processes the images to determine some or all of the dimensions of the package.

In some cases, it would be desirable to determine the dimensions of a package (or other object) using a device that is not fixed in position relative to the package. For example, in many cases it would be advantage to have a hand held device that could be carried by a user, and used to capture the dimensions of objects. It would be advantageous if such a handheld device could accurately and quickly determine the dimensions of the object without regard to the orientation of the object relative to the device.

### SUMMARY

The inventors have realized that the devices, systems, and methods described herein may be used to conveniently acquire the dimensions of an object, e.g., using a handheld device. In some embodiments, depth images of the object are obtained, e.g., using in infrared three dimensional (3D) camera. The depth images are processed to determine dimension data.

In some embodiments, the object to be dimensioned is known to be of a general shape (e.g., a hexahedron or, more specifically, a cuboid), and the image processing is designed to leverage this shape information to more accurately and/or efficiently determine the dimensions of the object based on the depth images.

For example, in some embodiments, a depth image is processed to find a “hot spot” that likely corresponds to a corner of a cuboid object. As detailed herein, based on the identified “hot spot”, and using the fact that three orthogonal faces of the cuboid meet at this corner, the depth image can be processed to identify segments of the depth image corresponding to the faces. The resulting segmented image can then be used to accurately and efficiently determine the dimensions of the object.

In one aspect, a method of determining dimension information indicative of the dimensions of an object is disclosed, the method including: receiving a depth image of the object; and processing the depth information. The processing includes: determining a region of interest (ROI) in the image corresponding to a corner of the object; generating local normal information indicative of local normals corresponding to points in the image; generating, based at least in part on the ROI and the local normal information, object face information indicative of an association of points in the image with faces of the object; and determining the dimension information based at least in part on the object face information.

In some embodiments, the object is substantially cuboid in shape, and the dimension information includes information indicative of the length, width, and height of the cuboid.

In some embodiments, generating object face information includes: estimating the location of the corner of the object based on the ROI; and identifying, based on the local normal information, object points in the image corresponding to points located in planes passing through the ROI based on the local normal information.

In some embodiments, the identifying object points includes identifying points in the image corresponding to points located in planes passing within a threshold distance from the location of the corner. In some embodiments , generating object face information further includes: generating segmentation information indicative of a distribution of the object points; and estimating the location of the faces of the object based on the segmentation information.

In some embodiments, estimating the location of the faces of the object based on the segmentation information includes: determining an orthogonal triplet of axes based on the segmentation information.

In some embodiments, determining the dimension information based at least in part on the object face information includes: projecting each of the object points onto one of the three axes; and determining the dimension information based on the projection.

Some embodiments include obtaining the depth image, e.g., using a device that is not fixed in location relative to the object. In some embodiments the device includes a hand held device. In some embodiments, the device includes an infrared 3D camera.

Some embodiments include outputting the dimension information.

In some embodiments, some, substantially all, or all of the processing of the depth information is carried out on a computer processor.

Some embodiments include, prior to generating the local normal information, applying a low pass spatial filter to the depth image.

In another aspect, an apparatus for determining dimension information indicative of the dimensions of an object, the apparatus including: a processor configured to receive a depth image of the object; and process the depth information, In some embodiments, the processor is configured to: determine a region of interest (ROI) in the image corresponding to a corner of the object; and generate local normal information indicative of local normals corresponding to points in the image; generate, based at least in part on the ROI and the local normal information, object face information indicative of an association of points in the image with faces of the object; and determine the dimension information based at least in part on the object face information.

In some embodiments, the object is substantially cuboid in shape, and where the dimension information includes information indicative of the length, width, and height of the cuboid.

In some embodiments, the processor includes a segmentation module configured to generate object face information, the segmentation module configured to: estimate the location of the corner of the object based on the ROI; and identify, based on the local normal information, object points in the image corresponding to points located in planes passing through the ROI based on the local normal information.

In some embodiments, the segmentation module is configured to: identify object points by identifying points in the image corresponding to points located in planes passing within a threshold distance from the location of the corner.

In some embodiments, the segmentation module is configured to: generate segmentation information indicative of a distribution of the object points; and estimate the location of the faces of the object based on the segmentation information.

In some embodiments, the processor includes an orthogonal triplet selection module configured to estimate the location of the faces of the object based on the segmentation information by determining an orthogonal triplet of axes based on the segmentation information.

In some embodiments, the processor includes a dimensioning module configure to determine the dimension information based at least in part on the object face information by: projecting each of the object points onto one of the triplet of axes; and determining the dimension information based on the projection.

Some embodiments include a sensor configured to generate the depth image of the object and transmit the image to the processor. In some embodiments the sensor is not fixed in location relative to the object. Some embodiments include a hand held device including the sensor. In some embodiments, the hand held device includes the processor. In some embodiments, the processor is located remotely from the hand held device.

In some embodiments, the sensor includes an infrared 3D camera

Some embodiments include an output module for outputting the dimension information.

Some embodiments include a filter module configured to apply a low pass spatial filter to the image.

Some embodiments include a handle unit including a sensor configured to generate the depth image of the object and transmit the image to the processor. In some embodiments, the processor is incorporated in a computing device mounted on the handle unit.

In some embodiments, the computing device includes at least one selected from the list consisting of: a tablet computer; a smart phone; and a laptop computer.

In some embodiments, the computing device is detachably mounted on the handle unit.

In some embodiments, the handle unit includes at least one data connection configured to provide data communication with the computing device.

In some embodiments, the data connection includes at least one from the list consisting of: a wired connection, a wireless radio frequency connection, a wireless inductive connection, and an optical connection.

In another aspect, a computer program product is disclosed including a non-transitory computer readable medium having a computer readable program code embodied therein, the computer readable program code configured to be executed to implement any of the methods described herein.

As used above, the term region of interest (“ROI”) is synonymous with the term “hot spot” used below.

Various embodiments may include any of the features described above, alone or in any suitable combination.

### BRIEF DESCRIPTION OF THE DRAWINGS

FIG. 1 is an illustration of a system for determining the dimensions of an object.

FIG. 2 is an illustration of a dimension capture device.

FIG. 3 is a schematic showing the relative orientation of a depth image sensor and a cuboid object.

FIG. 4 is an illustration of a process for determining the dimensions of an object. The left inset illustrates a 2D distribution generated in an object segmentation step. The right inset illustrates the determination of an orthogonal triplet based on the 2D distribution.

FIG. 5A illustrates the determination of whether a point on an object is coplanar with a hot spot point corresponding to a corner of the object.

FIG. 5B illustrates the local normals determined for three faces of a cuboid object, in the presence of noise.

FIG. 5C illustrates a 2D distribution corresponding to the local normals shown in FIG. 5B, where each of the three clusters of points corresponds to a visible face of the cuboid object. Arrows indicate a best estimate for a orthogonal triplet of axes for the object based on the distribution.

FIG. 6 is a block diagram of a processor for determining the dimensions of an object.

FIG. 7A is an illustration of a dimension capture device.

FIG. 7B shows a variety of views of the dimension capture device of FIG. 7A.

FIG. 8 shows an exemplary display from the dimension capture device of FIG. 7A.

### DETAILED DESCRIPTION

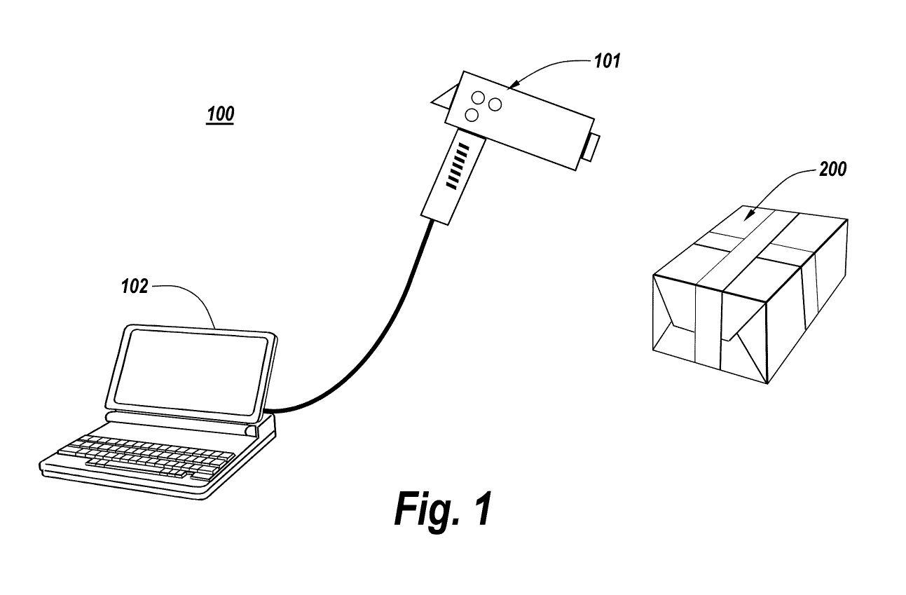

FIG. 1 illustrates a system 100 for capturing the dimensions of an object 200. The system 100 includes a dimension capture device 101 that is used to capture one or more depth images of the object 200. A processor 102 is in functional communication with the dimension capture device 101 (e.g., via a wired or wireless communication link). The processor 102 receives the depth images and processes the images to determine one or more dimensions of the object 200. In some embodiments at least three dimensions of the object are determined (e.g., the length, width, and height).

In some embodiments, the position of the dimension capture device 101 is not fixed relative to the object 200. For example, as shown, the dimension capture device 101 is a hand held unit. The hand held unit allows a user to move about, and to quickly and conveniently capture the dimensions of objects in various locations and orientations. In some embodiments, the object 200 is stationary. In some embodiments, the object 200 may be moving, e.g., on a conveyor belt.

Although FIG. 1 shows the dimension capture device 101 as separate from the processor 102, in some embodiments, some or all of the processor 102 may be integrated with the dimension capture device 101. In some embodiments, the processor 102 may be located remotely from the dimension capture device 101 (e.g., where the device 101 communicates with the processor 102 via a wireless communication network).

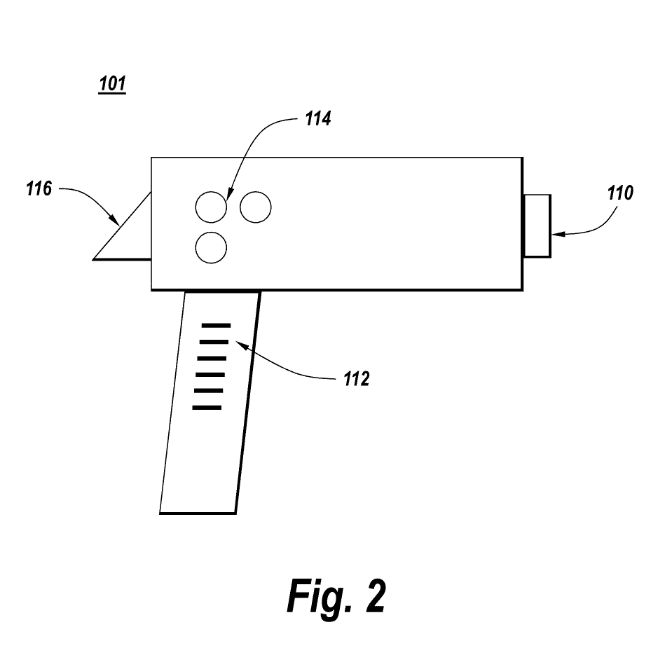

FIG. 2 shows a detailed view of the hand held dimension capture device 101. The device includes a sensor unit 110 that obtains one or more depth images (e.g., a stream of depth images). In various embodiments, the sensor unit 110 may be any suitable sensor capable of providing depth images. In some embodiments, the sensor 110 may include a three dimensional (3D) infrared (IR) camera.

In some embodiments, the IR 3D camera includes an infrared illuminator (e.g., an LED or laser projector) and sensor, such as a CMOS sensor. The infrared lilluminator projects near-infrared light and the sensor receives the returning light. In various embodiments, the IR camera is insensitive or substantially insensitive to changes in ambient lighting in the visible spectrum.

In some embodiments the infrared illuminator illuminates the field of view of the camera with a structured light pattern. The depth image can then be generated using suitable techniques known in the art, including depth from parallax techniques and depth from focus techniques. Examples of such techniques may be found, e.g., in U.S. Pat. No. 8,050,461, issued Nov. 1, 2011, the entire contents of which are incorporated by reference in their entirety.

In some embodiments, the IR 3D camera may be of the type available from PrimeSense Ltd. of 104 Cambay Ct. Cary, N.C., which interprets 3D scene information from a continuously-projected infrared structured light. For example, one PrimeSense 3D scanner, marketed as Light Coding, employs a variant of image-based 3D reconstructions. Light Coding works by coding the scene volume with near-IR light. The IR Light Coding is invisible to the human eye. A sensor, such as a CMOS image sensor, reads the coded light back from the scene. PrimeSense's system on a chip (SoC) is connected to the sensor and executes a parallel computational algorithm to decipher the received light coding and produce a depth image of the scene. The sensor is generally unaffected by ambient lighting changes, especially those in the visible portion of the spectrum.

In some embodiments, the IR 3D camera includes an infrared laser projector and a sensor such as a CMOS sensor. The infrared laser projector transmits infrared light onto the object and measures its “time of flight” after it reflects off an object, similar to sonar technology. The infrared laser projector pulses infrared light towards the object at a frequency of, e.g., several megahertz. The pulses are reflected back, captured by the sensor 606 and turned into a distance measurement to determine depth or height of an object.

In some embodiments, the IR 3D camera encodes information in the infrared light patterns emitted by the infrared laser projector, the infrared laser projector emits the light onto the object, and the sensor captures and analyzes the deformation of the patterns resulting from the encoding of the infrared light. The deformations in the light patterns are caused by object's presence. Detecting and using the deformations of the infrared light patterns can help generate finer image of the object's three-dimensional texture.

In various embodiments, any other suitable sensor for generating a depth image may be used.

In addition to a sensor for obtaining depth images, the sensor unit 110 may include other types of sensors. For example, the sensor unit 110 may include a conventional camera used to capture two dimensional (2D) images of the object 200. Any suitable camera can be used, e.g., a digital color or black and white camera. The 2D camera may be used to capture a single image, multiple images, a video stream, etc., of the object 200. In some embodiments the conventional camera may be a component of the IR 3D camera. For example, when the IP 3D camera includes a 2D IR camera used in conjunction with a structured light projector, the 2D IR camera may be used as a conventional cameral by selectively switching off the structured light projector.

In some embodiments, the sensor unit 110 may include other types of sensors including, e.g., a bar code reader, a distance senor (e.g., a sonic or light based distance sensor), a light level sensor for detecting ambient lighting conditions, a radio frequency identification (RFID) device (e.g., for reading an RFID tag on the object 200), etc. In various embodiments the sensor units may include one or more illumination devices for illuminating the object 200. In some embodiments the sensor unit may include one or more aim assisting devices, e.g., a laser aiming beam used to aid in aiming the dimension capture device at the object 200.

As shown, the dimension capture device 101 is a handheld unit including a handle 112 that can be gripped by the user. Although a “ray gun” shape is shown, it is to be understood that ay suitable form factor may be used. For example, in some embodiments the device 101 may have a form factor similar to that used for a cellular phone or a tablet computer device.

In some embodiments, the device 101 need not be hand held, but can instead be integrated into a unit worn by the user, e.g., as eye wear, a head piece, a shoulder mounted piece, etc.

The device 101 may include one or more control devices 114. As shown, the control devices are in the form of push buttons, however any other suitable controls may be used. For example, various embodiments may include a keyboard, a touch screen, a switch, etc. The control devices 114 may control any aspect of the system 100. For example, the control devices 114 may be used to control the functioning of the sensor unit 110, the communication between the dimension capture device 101 and the processor 102, etc.

In some embodiments, the dimension capture device 101 includes a display unit 116. The display unit 116 may include any suitable display. For example, the display unit may include one or more indicators, e.g., to indicate successful capture of dimensions of the object 200. In some embodiments, the display unit 116 may include a screen that can display images of the object (e.g., based on the depth or other images captured by the sensor unit 110) or other information (e.g., dimension information output from the processor 102).

In various embodiments, processor 102 receives a depth image of the object 200 from the sensor unit 110 of the dimension capture device 101 and processes the image to determine the dimensions of the object 200. As described above, in typical embodiments, the position of dimension capture device 101 is not fixed relative to the object 200. Thus, the dimensions of the object 200 must be determined without the benefit of pre-existing information about the relative position or orientation of the dimension capture device 101 and the object 200.

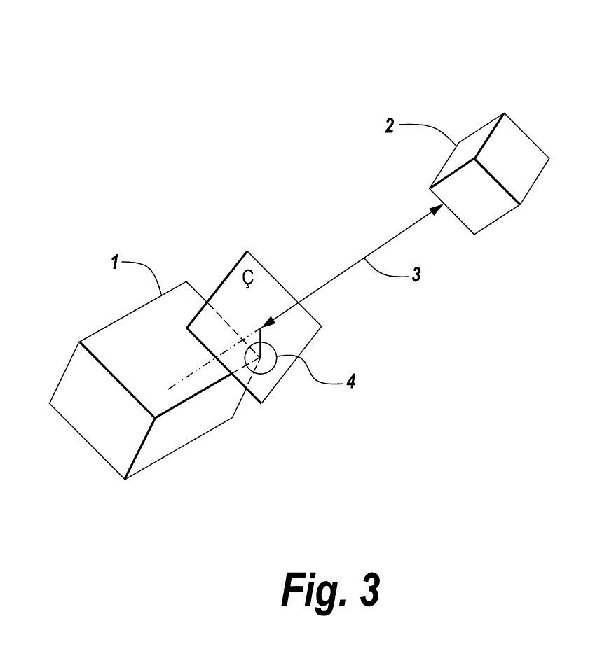

FIG. 3 shows a general illustration of the dimensioning problem. Here, the object 200 is a hexahedron or, more specifically, a cuboid 1. The dimension capture device 101 (not shown) includes a sensor 2 for obtaining a depth image. It is assumed in the following that the sensor 2 is aimed such that at least two of the faces of the cuboid 1 are visible to the sensor.

Regardless of location and orientation, the point of the cuboid 1 that exhibits the smallest depth measure 3 is very unlikely to be anything else but one of its corners. This 3D location (referred to herein as a “hot spot”) 4 is particularly interesting because of the two following properties. First, as the point with minimal depth measure, it is particularly easy to find from the raw depth data provided by the sensor 2. The point, being nearest corner of the cuboid, must belong to all of the cuboid's visible faces.

In a variety of applications, a dimensioning problem of the type described above presents a number of technical challenges. Provided with a depth image composed of a point cloud of depth measurements, one must isolate the object of interest from the rest of the scene. Furthermore, as the depth measures can reveal no more than half of the item, one also needs to extract relevant geometrical features in order to measure it. These challenges fall under the general category of data segmentation as they aim to label each datum with either the object or the geometrical feature it belongs to.

For many types of known sensors, depth images may be noisy. For instance, some sensors known in the art provide less than a 10 mm precision in its estimation of depth. Accordingly, one must account for this noisiness before one considers any derivatives of these measures for the purpose of geometric feature extraction. Depth data also has the tendency to be sparse. In many cases, single frame's worth of depth data will exhibit areas in the field of view where the depth is simply unknown.

In various applications, the problem may be too complex and computationally expensive for conventional techniques. As is recognized in the art, turning a depth image point cloud into a small, manageable and meaningful set of polygons is not an easy problem in general. Approaches employing iterative techniques such as random sampling consensus (RANSAC) or region growing may be memory and/or computationally prohibitive. Similarly, 3D generalizations of 2D image processing techniques such as the Hough transform are generally also memory and/or computationally prohibitive.

In various embodiments, the techniques described herein may be used to overcome the technical challenges noted above. In some embodiments, as detailed below, a process is used that restricts its attention to features that are located around or coplanar with a single 3D location, the hot spot 4. The algorithm then uses a mixture of local and distributed features in order to detect the object's proper orientations and isolate it from the scene.

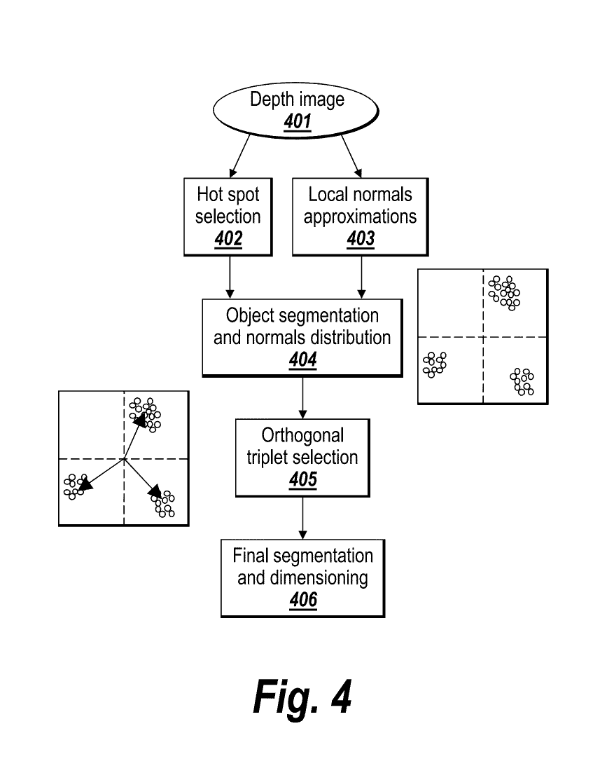

FIG. 4 illustrates an exemplary process 400 for dimensioning an object based on a depth image. In step 401 at least one depth image is received, e.g., from the sensor unit 110 of the dimension capture device 101.

In step 402 the depth image is processed to determine the hot spot of the object to be dimensioned. As used herein, a depth image is an image for which each pixel value conveys a distance between the sensor 2 used to obtain the image, and a corresponding point in the field of view of the sensor. In some embodiments, selection is based on the data point (or region of points) that exhibits the smallest depth value in a portion of the depth image, e.g., within a central zone of interest in the sensor's field of view. As discussed previously, this hot spot point 4 almost certainly corresponds to a corner of a cuboid object 1.

In step 403, the raw depth image is processed to determine the local normal corresponding to points in the image. These local normals can be determined based on taking a spatial derivative of the depth data, using techniques known in the art. An example can be found Murillo, Feature Track and detection at available at http://w3.impa.br/˜francisc/IProc/report.html.LyXconv/report.html (accessed May 11, 2012).

In some embodiments, e.g., where the raw depth image is noisy, a filter or other processing may be applied to the depth image prior to determining the local normals. For example, a low pass spatial filter may be applied to the raw image data.

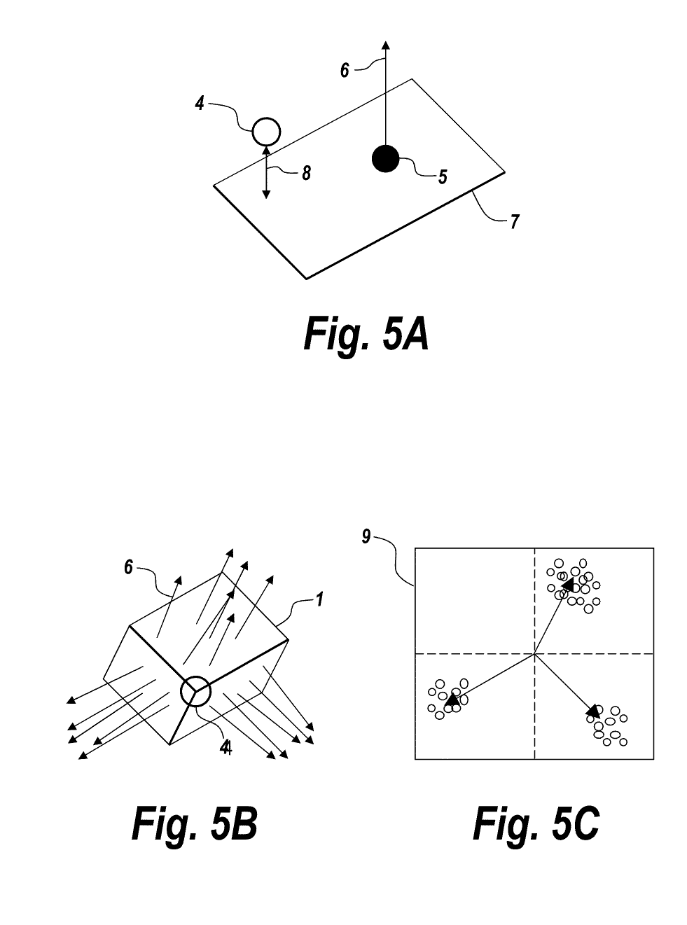

In step 404, object segmentation is performed based on the hot spot determined in step 402, and on the local normals information generated in step 403. As illustrated in FIG. 5A, one may use the approximations for the local normals 6 in order to assert whether a data point 5 appears to belong to a plane 7 (as defined by the normal 6) that passes through the hot spot 4. If the distance 8 between the hot spot 4 and the plane 7 is below a set tolerance, this data point 5 will be marked as potentially belonging to the cuboid object 1. The local normal approximation will then be added to a 2D distribution 9 as shown in FIG. 5C. This process can be iteratively repeated, identifying additional points potentially belonging to the object 1, and adding the corresponding local normals to the 2D distribution 9.

The distribution 9 (shown in FIG. 5C and the right hand inset of FIG. 4) can be seen as an accumulator of the normals' projections for the object 1 onto the sensor's image plane. As one proceeds this way through each point in the depth image, this accumulator will convey the distribution of orientations for planes that appear to pass through our hot spot. That is, clusters of points in the distribution 9 with likely each correspond to a nomals from a respective planar face of the object 1

In step 405 an orthogonal triplet corresponding to the cuboid object 1 is determined. Ideally, if the object were a perfect cuboid and the normal measures were error-free the distribution would end up consisting of three orientations, each one corresponding to the projection of one of the cuboid's visible faces onto the sensor's image plane. Realistically though, one is more likely to get a few clusters. Additionally, only two faces might be visible.

For example, FIG. 5B illustrates local normals 6 to the cuboid 5 in the presence of noise. FIG. 5C (also the left inset of FIG. 4) shows the corresponding 2D distribution.

One does do know however that the cuboid's faces are orthogonal with respect to one another. Accordingly one may estimate which triplet of orthogonal orientations best explains the distribution gathered, as shown in FIG. 5C (also the left inset of FIG. 4). This orthogonal triplet is the estimation of the cuboid's proper axes. The orthogonal triplet may be determined by any suitable method, e.g., a constrained least squares optimization technique.

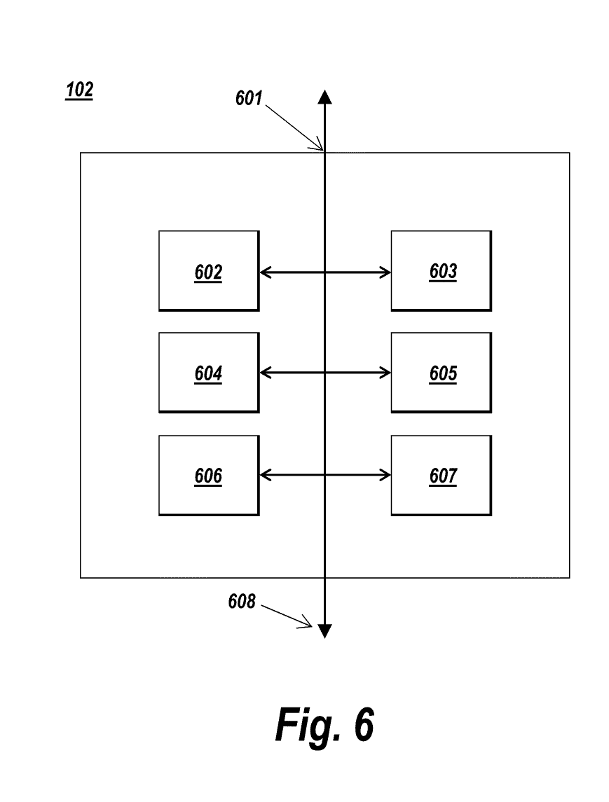

Note that in the case of only two visible faces, FIG. 6C would show only two clusters. The third orthogonal axis would be chosen normal to the image plane of the senor 2.

Referring back to FIG. 4, in step 406, a final segmentation and dimensioning is performed. The data points retained as potentially belonging to the object of interest in step 404 are projected onto the axes estimated in step 405. The length of these projections provides basis for the estimation of the object's three dimensions.

In an additional step, the dimensions of the object, or related information, may be output.

FIG. 6 shows a functional block diagram of the processor 102. The processor 102 includes an input 601 that receives depth images from the dimension capture device 101. A hot spot module 602 processes the depth image to identify a hot spot in the image that is likely to correspond to a corner of the object of interest. In some embodiments, the hotspot is determined by finding a point or region corresponding to a minimum depth from the sensor used to acquire the depth image.

A local normals module 603 processes the depth image to determine the local normals at points on the image. In some embodiments, the local normals module operates with a pre-processing module 604 that processes the depth image prior to determining the local normals. For example, in some embodiments, the pre-processing module 604 applies a low pass spatial filter to the depth image.

A segmentation module 605 receives hot spot information from the hot spot module 602 and local normals information from the local normals module 603. The segmentation module 605 processes this information to identify local normals that are likely to correspond to points on the object to be dimensioned. In some embodiments, the segmentation module produces a 2D distribution of the identified normals. As described above, clusters in the 2D distribution will each correspond to a respective face of the object.

An orthogonal triplet module 606 estimates which triplet of orthogonal orientations best explains the distribution produced by the segmentation module. This orthogonal triplet is the estimation of the cuboid's proper axes. The orthogonal triplet may be determined by any suitable method, e.g., a constrained least squares optimization technique.

A dimensioning module 607 performs a final segmentation and dimensioning. The data points identified by the segmentation module 605 as potentially belonging to the object of interest are projected onto the axes estimated by the orthogonal triplet module 606. The length of these projections provides basis for the estimation of the object's three dimensions.

The processor 102 may include an output 608 for outputting dimension information.

Various embodiments of the devices, systems, and methods described herein may include one or more of the following features.

The system 100 may include a PSD (Postal SecurityDevice), e.g., included in the processor 102

The system 100 may use available information (e.g. from an intranet or internet connection, an integrated global positioning system device, etc.) to establish the location of the object 200.

The system 100 may include a secure “black box” data recorder for audit and control purposes. This capability can be remotely accessed (e.g. via an intranet or internet connection).

The system 100 may include cryptographic capabilities, e.g., consistent with export regulations.

User management and tokens may be supported. Departmental accounting may be provided. SAP codes may be supported.

In various embodiments, work flow systems integration and support for manufacturing systems will be available. Dashboard facilities with remote access will be supported. Automatic integration with dispatch centers will be supported. Embedded wireless broadband will be available. Ability to read full size checks and bill payment forms may be included. Ability to capture signed documents may be included.

In various embodiments, various peripheral devices may be supported including but not limited to: card readers, printers, postal label printers, interactive customer display, pin Input devices, and keyboards.

As noted above, in some embodiments, the dimension capture device 101 includes a conventional camera (e.g., an RGB camera). For example, the conventional camera may be used to acquire an image of the object 200. This image may be associated with the determined dimensions of the object or any other suitable information related to the object. In some embodiments, a conventional image of the object can be processed to identify text or other markings on the object. These markings can be processed using optical character recognition (OCR) techniques. In general, conventional images of the object may be processed using any of the techniques described in the Enrollment Applications incorporated by reference above.

The conventional camera may be used for other purposes, e.g., for conveniently acquiring information related to the dimensioned object. For example the cameras could be used to acquire information found on customs forms, bills of sale, packing lists, etc. and/or customer payment information. In general, the camera may be used to implement any of the techniques described in the Enrollment Applications.

In some embodiments, information determined using the conventional camera may be used to verify or refine dimension information generated using the depth camera. For example, in some applications, a depth image may be relatively noisy. In some such cases, once an object has been identified and dimensioned using the noisy depth image, this information may be used to identify the corresponding object in the less noisy conventional camera image (e.g., using information regarding the relative orientations of the two cameras). Any suitable machine vision techniques (e.g., edge detection techniques) may then be applied to the object in the conventional image to provide supplementary information regarding the object (e.g., a refined or higher precision estimate of one or more of the object's dimensions).

It is to be understood that while the examples above have been directed to dimension capture applications, the processing techniques described herein may be used in any suitable application. For example, these techniques may be implemented in a machine vision system, e.g., for locating and/or determining the size of objects.

In some embodiments, the techniques described herein may be used to process data other than depth images where pixels in the image correspond to a distance from a sensor to an object in the sensor's field of view. For example, the processing techniques described herein may be applied for segmenting other types of images including, e.g., medical images, seismic images, etc.

In general, the depth images may be generated using any suitable type of sensing including optical sensing (e.g., parallax type schemes of the type described above, RADAR, LIDAR, sonic range finding, etc.).

In some embodiments, the techniques described above maybe be used to determine the dimensions of an object in real time or substantially real time That is, in some embodiments the dimension data is output less that 5 seconds, less than 1 second, less than 0.1 seconds, or less than 0.01 seconds after the depth image is initially acquired. In some embodiments, the dimension information is output substantially simultaneously with the image acquisition.

In some embodiments, the dimensions of the object are determined with an accuracy of +/−10 cm, 5 cm, 1 cm, 0.1 cm, 0.01 cm, 0.001 cm or better. In some embodiments, this accuracy can be obtained using depth images with accuracy no better than +/−10 mm.

In some embodiments, the processing techniques described above may be applied to previously acquired image data. For example processor 102 may receive images from a database of stored images rather than directly from the dimension capture device 101.

While the examples above describe the processing of a single depth image of an object, it is to be understood that in some embodiments multiple images maybe used. For example, multiple sparse depth images acquired within a short time of each other (e.g., short enough that motion of the dimension capture device 101 is not an issue) may be combined to generate a composite image. This composite image may then be processed as described above.

In some embodiments, each of several images can be separately processed to determine the object dimensions. The repeated dimension measurements can then be combined (e.g. averaged) to produce an improved dimension estimate. In some embodiments, the multiple dimension measurements may be used to estimate the accuracy of the measurements. For example, if the dimensions found in the multiple measurements differ from each other by more than a threshold amount, a error warning may be output indicating a possibly faulty result.

In the examples presented above, the dimensions of an object are determined solely from a depth image without the use of any predetermined information about the location or orientation of the object. However, in some embodiments, such information, when available, may be used to supplement, aid, or confirm the dimensioning process.

For example, in applications where the object is expected to to lie flat on the ground, the dimension capture device may include a sensor (e.g., a MEMs accelerometer or gyroscope, or other inertial sensor) that provides some information about the orientation of the device 101 with respect to the ground. This information could be used to indicate a likely error if the depth image processing identifies an object in an unlikely orientation (e.g., standing on edge relative to the ground).

As will be understood by those skilled in the art, the devices, systems and techniques described herein may be used in a variety of applications including, but not limited to: parcel enrollment, chain of custody management, supply chain management. The dimension capture functionality may be used for 3D modeling or printing, computer generated image applications, surveying applications, etc.

### Alternate Embodiments

Although the examples above have been directed to dimensioning box shaped objects. However, as will be understood by those skilled in the art in view of the present disclosure, the techniques described herein may be adapted in a straightforward fashion for use with other types of polyhedronal objects (e.g., pyramidal objects, octahedron objects, etc.)

In some embodiments, techniques of the types described herein may be used to capture the dimensions of objects having one or more curved surfaces. For example, in some embodiments, the dimensions of a cylindrical object (e.g., a barrel shaped container) may be obtained. For such an object, the depth image may be processed to indentify a “hot spot” corresponding to the closet point on the object. Local normals may then be found in the region of the depth image at or near this spot. A cylindrical surface may be indentified as corresponding to a region where all of the normals, if extended, converge onto a straight line (i.e., the cylindrical axis of the cylindrical object). The radius of the object may then be determined as the distance from the identified surface to the cylindrical axis. The length of the cylinder may then be determined in a straightforward fashion, e.g., by identifying the flat faces associated with the top and bottom of the cylinder using techniques of the type described above.

A similar approach may be used for dimensioning spherical objects. For such an object, the depth image may be processed to indentify a “hot spot” corresponding to the closet point on the object. Local normals may then be found in the region of the depth image at or near this spot. A cylindrical surface may be indentified as corresponding to a region where all of the normals, if extended, converge onto a point (i.e., the center of the spherical object). The radius of the object may then be determined as the distance from the identified surface to the center point.

In various embodiments, the devices provided herein may operate in multiple modes for detecting and dimensioning objects in multiple shape classes. In some embodiments, the mode may be user selected. In other embodiments, the device may switch between modes automatically, e.g., by searching for a best fit for a given object.

The various embodiments described above described identifying and dimensioning a single object within a depth image. However, in some embodiments, the techniques described herein may be applied to identifying and dimensioning multiple objects within a single depth image or a set of depth images. In some embodiments, this may be accomplished in an iterative fashion. For example, a first object (e.g., the closest relevant object) may be identified and dimensioned. The area in the depth image corresponding to this object may then be blanked or otherwise removed from consideration. The process in then repeated, identifying and dimensioning a second object, and then blanking the depth image region corresponding to the second object. The process may continue until all objects in the image (or a scene composed of multiple images) have been identified and dimensioned. Note that in various embodiments, other information related to the objects may be collected (e.g., OCR of printed labels, barcode information, RFID tag information, etc.) and associated with the captured dimension information.

A multiple object dimension capture process of the type described above may be particularly useful in application where in is desirable to obtain an inventory of objects in a particular defined region (e.g., a room).

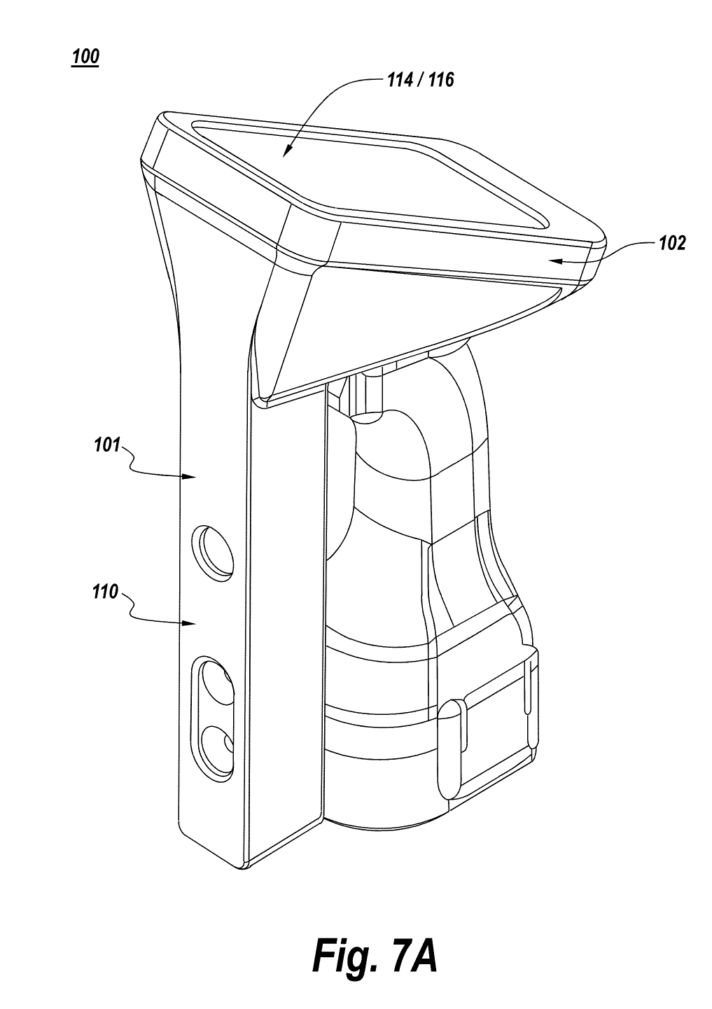

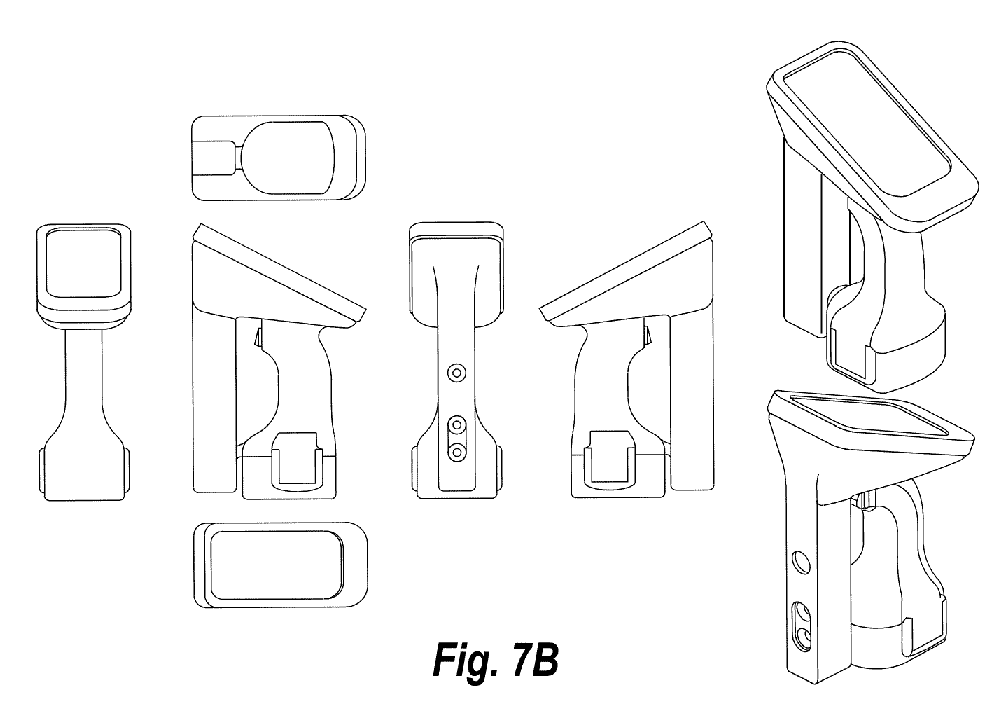

FIGS. 7A and 7B show an exemplary embodiment of the system 100 for capturing dimensions of an object 200 (not shown) configured as an integrated hand held unit that includes a dimension capture unit along with a processor. The functional components are substantially similar to those describe din reference to FIGS. 1 and 2 above. In the embodiment shown, the sensor unit 110 is mounted on a handle shaped unit. A computing device (as shown a smart phone device) mounted on the handle and serves as the processor, and input/display unit 114/116. In various embodiments, other types of computing devices may be used, e.g., a tablet computer, laptop computer etc. The handle may include a power source (e.g., a rechargeable battery) that provides power to the sensor unit 110 and/or the computing device. The handle may also include a data connection between the computing device and the sensor unit (e.g. a wired, wireless, optical or other data connection). The handle may also include further control devices, e.g., as shown, a trigger button that can communicate with the computing device and/or the sensor unit 110. The handle may also include any suitable peripheral devices of the type described herein (e.g., bar code reader, RFID reader, illumination device, printer, wired, wireless, or optical data communication unit, etc.). In some embodiments, the computing device may be detachable from the camera.

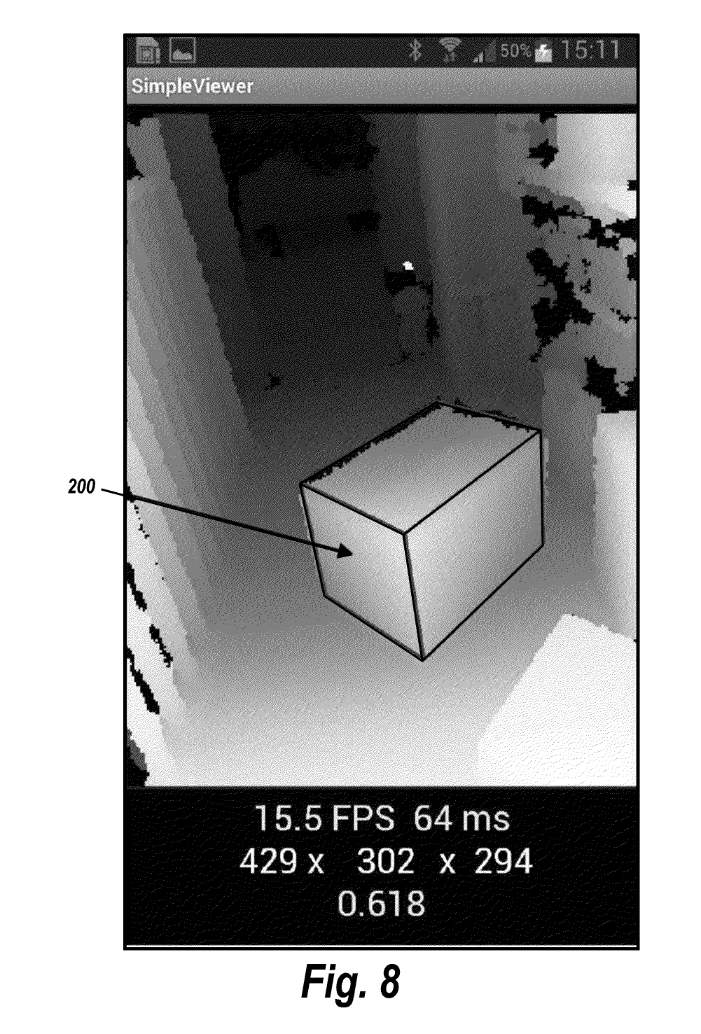

FIG. 8 shows an exemplary output from the display of the device shown in FIGS. 7A and 7B. The display shows the depth image acquired by the 3D, along with an overlay corresponded to outline of an object 200 of interest as determined using the techniques described here. In some embodiments, the user may confirm the match between the overlay and the image, e.g., by pulling a trigger button, causing storage of dimension capture information for the object 200 in memory. In some embodiments, the display includes additional information including the measured dimensions of the device, sensor operating parameters, battery charge information, etc.

In various embodiments, other suitable display arrangements may be used. In some embodiments, a conventional camera image may be used instead of the depth image. In some embodiments, the device may include a projector (e.g., a laser projector) that displays information (e.g., measured dimensions) directly onto or near the object 200.

### Exemplary Applications

The devices techniques described have commercial applications in a variety of market segments, including but not limited to:

### Managed Content

The evolution of the letter stream as a facility to carry packets suitable for delivery to unattended delivery points requires the addition of infrastructure allowing that activity. The enrolment of such items requires the ability to capture all of the information required for all items to be sent through the mail stream as well as new value added services. The ability to tag items with services such as cold stream, work flow notifications, risk management, call center notifications, and conditional deliveries will be required. In some embodiments, an enrollment device including the technology described herein, can be used in locations such as pharmacies or dedicated shipping centers where prescriptions were being prepared for shipment to patients.

### Postal Operators & Courier Companies

For the highly automated postal operators and courier companies, an enrollment device using the technology described herein may provide automated “front end” data collection, leveraging their existing investment in systems and technology. For the low or non-automated strata of postal operators and courier companies, the enrollment device provides a low-cost automation solution for the capture and management of shipment related information at their counter locations, eliminating a range of paper-based processes and enabling integration with 3rd party carriers and systems.

### The Pharmaceutical Industry

An enrollment device using the technology described herein may be used to provide the pharmaceutical industry with a means of automating the Provenance and Chain of Custody aspects of their business.

### Civil Defense

An enrollment device using the technology described herein may be used to provide a mechanism for the mass distribution of products and services with a clear Chain of Custody from point of Induction.

### Goods Distribution Companies

An enrollment device using the technology described herein may be used to provide goods distribution companies with the ability to use the enrollment device to manage and prepare their “one-to many” shipments.

### CONCLUSION

One or more or any part thereof of the techniques described above can be implemented in computer hardware or software, or a combination of both. The methods can be implemented in computer programs using Standard programming techniques following the examples described herein. Program code is applied to input data to perform the functions described herein and generate output information. The output information is applied to one or more output devices such as a display monitor. Each program may be implemented in a high level procedural or object oriented programming language to communicate with a computer system. However, the programs can be implemented in assembly or machine language, if desired. In any case, the language can be a compiled or interpreted language.

Moreover, the program can run on dedicated integrated circuits preprogrammed for that purpose. Each such computer program is preferably stored on a storage medium or device (e.g., ROM or magnetic diskette) readable by a general or special purpose programmable computer, for configuring and operating the computer when the storage media or device is read by the computer to perform the procedures described herein. The computer program can also reside in cache or main memory during program execution. The analysis method can also be implemented as a computer-readable storage medium, configured with a computer program, where the storage medium so configured causes a computer to operate in a specific and predefined manner to perform the functions described herein. A number of embodiments of the invention have been described. Nevertheless, it will be understood that various modifications may be made without departing from the spirit and scope of the invention.

As used herein the terms “light” and “optical” and related terms are to be understood to include electromagnetic radiation both within and outside of the visible spectrum, including, for example, ultraviolet and infrared radiation.

Some of the examples above refer to a package received by the enrollment device. It is to be understood that suitable item may be received and enrolled, including: mail pieces, pharmaceutical items, evidentiary items, documents, containers of any type, etc.

A number of references have been incorporated in the current application. In the event that the definition or meaning of any technical term found in the references conflicts with that found herein, it is to be understood that the meaning or definition from the instant application holds.

The scope of the present invention is not limited by what has been specifically shown and described hereinabove. Those skilled in the art will recognize that there are suitable alternatives to the depicted examples of materials, configurations, constructions and dimensions. Numerous references, including patents and various publications, are cited and discussed in the description of this invention. The citation and discussion of such references is provided merely to clarify the description of the present invention and is not an admission that any reference is prior art to the invention described herein. All references cited and discussed in this specification are incorporated herein by reference in their entirety.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Variations, modifications and other implementations of what is described herein will occur to those of ordinary skill in the art without departing from the spirit and scope of the invention. While certain embodiments of the present invention have been shown and described, it will be obvious to those skilled in the art that changes and modifications may be made without departing from the spirit and scope of the invention. The matter set forth in the foregoing description and accompanying drawings is offered by way of illustration only and not as a limitation.

1. A method of determining dimension information indicative of the dimensions of an object, the method comprising:
receiving a depth image of the object; and
processing the depth information, the processing comprising:
determining a region of interest (ROI) in the image corresponding to a corner of the object;
generating local normal information indicative of local normals corresponding to points in the image;
generating, based at least in part on the ROI and the local normal information, object face information indicative of an association of points in the image with faces of the object; and
determining the dimension information based at least in part on the object face information.

2. The method of claim 1, wherein the object is substantially cuboid in shape, and wherein the dimension information comprises information indicative of the length, width, and height of the cuboid.

3. The method of claim 2, wherein generating object face information comprises:
estimating the location of the corner of the object based on the ROI; and
identifying, based on the local normal information, object points in the image corresponding to points located in planes passing through the ROI based on the local normal information.

4. The method of claim 3, wherein the identifying object points comprises identifying points in the image corresponding to points located in planes passing within a threshold distance from the location of the corner.

5. The method of claim 3, wherein generating object face information further comprises:
generating segmentation information indicative of a distribution of the object points; and
estimating the location of the faces of the object based on the segmentation information.

6. The method of claim 5, wherein estimating the location of the faces of the object based on the segmentation information comprises:
determining an orthogonal triplet of axes based on the segmentation information.

7. The method of claim 6, wherein determining the dimension information based at least in part on the object face information comprises:
projecting each of the object points onto one of the three axes; and
determining the dimension information based on the projection.

8. The method of claim 1, further comprising obtaining the depth image.

9. The method of claim 1, further comprising obtaining the depth image using a device that is not fixed in location relative to the object.

10. The method of claim 9, wherein the device is a hand held device.

11. The method of claim 10 wherein the device comprises an infrared 3D camera.

12. (canceled)

13. The method of claim 1, wherein processing the depth information is carried out on a computer processor.

14. The method of any claim 1, further comprising:
prior to generating the local normal information, applying a low pass spatial filter to the depth image.

15. An apparatus for determining dimension information indicative of the dimensions of an object, the apparatus comprising:
a processor configured to
receive a depth image of the object; and
process the depth information;
wherein the processor is configured to:
determine a region of interest (ROI) in the image corresponding to a corner of the object; and
generate local normal information indicative of local normals corresponding to points in the image;
generate, based at least in part on the ROI and the local normal information, object face information indicative of an association of points in the image with faces of the object; and
determine the dimension information based at least in part on the object face information.

16. The apparatus of claim 15, wherein the object is substantially cuboid in shape, and wherein the dimension information comprises information indicative of the length, width, and height of the cuboid.

17. The apparatus of claim 16, wherein the processor comprises a segmentation module configured to generate object face information, the segmentation module configured to:
estimate the location of the corner of the object based on the ROI; and
identify, based on the local normal information, object points in the image corresponding to points located in planes passing through the ROI based on the local normal information.

18. The apparatus of claim 15, wherein the segmentation module is configured to:
identify object points by identifying points in the image corresponding to points located in planes passing within a threshold distance from the location of the corner.

19. The apparatus of claim 18, wherein the segmentation module is configured to:
generate segmentation information indicative of a distribution of the object points; and
estimate the location of the faces of the object based on the segmentation information.

20. The apparatus of claim 19, wherein the processor comprises an orthogonal triplet selection module configured to estimate the location of the faces of the object based on the segmentation information by determining an orthogonal triplet of axes based on the segmentation information.

21. The apparatus of claim 20, wherein the processor comprises a dimensioning module configure to determine the dimension information based at least in part on the object face information by:
projecting each of the object points onto one of the three axes; and
determining the dimension information based on the projection.

22. The apparatus of claim 15, further comprising a sensor configured to generate the depth image of the object and transmit the image to the processor.

23. The apparatus of claim 22, wherein the sensor is not fixed in location relative to the object.

24. The apparatus of claim 23, comprising a hand held device comprising the sensor.

25. The apparatus of claim 24, wherein the hand held device comprises the processor.

26. The apparatus of claim 24, wherein the processor is located remotely from the hand held device.

27. The apparatus of claim 22, wherein the sensor comprises an infrared 3D camera.

28. The apparatus of claim 15, further comprising an output module for outputting the dimension information.

29. The apparatus of claim 15, further comprising a filter module configured to apply a low pass spatial filter to the image.

30. The apparatus of claim 15, comprising a handle unit comprising a sensor configured to generate the depth image of the object and transmit the image to the processor; and wherein the processor is incorporated in a computing device mounted on the handle unit.

31. (canceled)

32. The apparatus of claim 30, wherein the computing device is detachably mounted on the handle unit.

33-35. (canceled)
